(19) United States
(12) Patent Application Publication
(10) Pub. No.: US 2012/0030978 A1
(43) Pub. Date: Feb. 9, 2012

(54) SIGNAGE DEVICE

(76) Inventor: Paul Anthony MILLER, London (GB)

(21) Appl. No.: 12/849,979

(22) Filed: Aug. 4, 2010

(51) Int. Cl. G09F 7/12; G09F 15/00

(52) U.S. Cl. 40/594; 40/606.01

(57) ABSTRACT

A signage device is provided for attachment of a sign or badge having a curved lower edge region to a surface such as a chair backrest. A supporting part consisting of a flat strip of curved configuration has a concavely curved upper edge and an annular framing part is attached in superimposed relationship to the supporting part to retain and frame the sign, which is removably inserted behind the frame and supported upon the supporting part. A lower edge of the sign and a midpoint of the upper edge of the supporting part have matching tongue and notch location means so that the sign is retained non rotatably in a defined orientation. The supporting part may be mounted on to a backing plate to enable attachment of the device to a wider range of substrates.

### TECHNICAL FIELD

This invention concerns a device for displaying a sign or logo for information or promotional purposes. In particular, though not exclusively, the invention relates to such a device when adapted for mounting, for example, to an article of furniture such as a chair. The device may also be termed “a badge mounting device” and the terms signage device and badge mounting device are used interchangeably in this specification.

### BACKGROUND ART

U.S. Pat. No. 2,143,583 describes an advertising sign particularly adapted for use at the rear of motor vehicles in the 1930s. It comprises a base in the form of a substantially flat disc intended to be secured by bolts or rivets to a bracket at the back of the motor vehicle. This base is in the form of a substantially flat, circular disc having a peripheral edge curled over to present an annular channel, said channel defining a central opening into which a correspondingly circular display plate can be inserted to lie flat against the base, said display plate being secured in that position by a split ring of tubular form of a size to clip into the channel overlying the periphery of the display plate. A pin projects from the base adjacent its bottom edge, just inside the peripheral channel and the display plate is provided with a radial slot at a location defining its bottom edge so that the display plate is appropriately orientated and located non-rotatably in the base when the slot is registered with and engaged on the pin. The display plate can be removed by first prising out the retaining split ring by inserting a tool via a notch in the outer edge of the channel. It can then be exchanged for a different display plate.

Nowadays, in conference centers, and in hotels and other establishments having conference, meeting and event facilities, many devices are used for displaying promotional material, for example the logo of an organization utilizing the conference facility.

An object of the present invention is to provide chairs with badge mounting devices whereby the badges are interchangeable as required, either to advertise the services provided by the conference facility such as by using a hotel or conference centre logo, or to display the logo of an organization using the conference facility, or to display any badge or picture or similar as desired by organizers of a social event, such as a wedding.

A further object of the present invention is to provide a badge mounting device which may be fixed to any display surfaces and allow badges to be mounted interchangeably in a quick and simple manner.

Yet a further object is to provide for quick and easy mounting of badges or signs whereby they remain reliably upright, or in appropriate required orientation when in position, thus avoiding the untidy appearance of several such signs disposed randomly at different angles.

### SUMMARY

The present disclosure provides a signage device for attachment to a surface from which a sign having at least partial edge curvature is to be displayed. The curved edge region of the sign is provided with a locating formation in the form of a tongue or a notch. A simple version of the device of the invention has a supporting part, for attachment to a surface, which consists of a flat strip of curved configuration having a concavely curved upper support edge to support the curved edge region of the sign and a framing part attached to the supporting part in superimposed relationship thereto to retain and frame the sign when the sign is supported upon the supporting part. The upper support edge of the supporting part has a location formation, namely a tongue or a notch, complementary to that of the sign, said formations engaging with each other to maintain the sign in a selected orientation and in a non-rotatable manner relative to the supporting part when, in use, the supporting part is attached to a surface and the sign is inserted behind the framing part.

A more robust version of the device, which is also better adapted for attachment to a wide variety of substrates, such as many different styles of chairs, doors or other display backing, also includes a backing plate to which the supporting part is attached.

The framing part may be integrally formed with or attached or attachable to the supporting part.

The sign may be a circular disc. Other shapes, such as oval or elliptical, are possible.

The supporting part may be a semi-circular strip of material, to match a circular disc.

However, in preferred embodiments the supporting part may have a lower edge of part circular shape, which may be of greater angular extent than semicircular and its curved upper edge may have a central region of no more than semicircular shape and respective tapering end regions which joined to the tips of the lower edge.

The framing part may be of annular form corresponding in radius to that of the supporting part, when the latter is semi-circular or has a part circular lower edge.

The location formations, namely the tongue or notch at the upper surface of the supporting part of the device, and complementary notch or tongue on the lower surface of the sign may be V-shaped for ease of inter-engagement.

The supporting and framing parts and the sign, and the backing plate when provided, may be formed from sheet material. The sheet material may be metallic or it may be of plastics.

The supporting and framing parts may be die cut in a single sheet of material and retained therein, until required for use, by bridging pieces.

The signage device may be combined with an article of furniture having a surface to which the device is attached, replaceably to display the sign.

### BRIEF DESCRIPTION OF DRAWINGS

Embodiments of the invention will now be described, by way of example only, with reference to the accompanying drawings in which:

FIG. 1 is an exploded perspective view of a first embodiment of a signage device in accordance with the invention;

FIG. 2 is an exploded perspective view of a second embodiment of a signage device in accordance with the invention;

FIG. 3 is a perspective view of the second embodiment with parts connected as viewed from the front;

FIG. 4 is a perspective view of the second embodiment with parts connected as viewed from the rear;

FIG. 5 is a front plan view of a backing plate of the second embodiment;

FIG. 6 is a corresponding side view of the backing plate of FIG. 5;

FIG. 7 is a front plan view showing a supporting part of the second embodiment attached onto the backing plate;

FIG. 8 is a corresponding side view of the connected parts in FIG. 7;

FIG. 9 is a front plan view of the fully assembled second embodiment, with a framing part overlying the supporting part; and

FIG. 10 is a corresponding side view of the second embodiment shown in FIG. 9.

### DETAILED DESCRIPTION

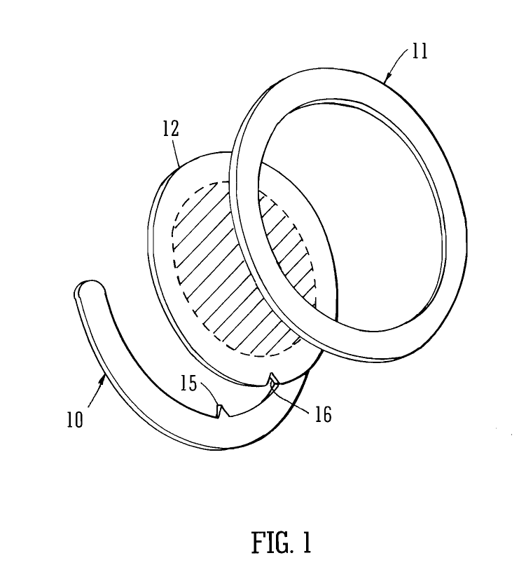

A first embodiment of a signage device of this invention, as shown in FIG. 1, comprises three parts, namely a supporting part 10, a framing part 11 and a sign 12 in the form of a substantially circular disc on which may be printed or engraved a company logo, for example, or other information.

The supporting part 10 and the framing part 11 may be cut from a single sheet of material, for example polished steel, and typically in the region of 1 mm to 2 mm in thickness. The sign 12 may similarly be formed in multiples from a single sheet of material of similar kind.

However, all of these parts may be produced from other suitable material, such as vinyl or other plastics material.

The supporting part 10 is of generally semi-circular form and the framing part 11 is annular, these parts having matching radius.

The supporting part 10, on its opposed faces, is provided with a self-adhesive material with a removable backing sheet whereby the annular framing part 11 may be attached to the part 10 in superimposed relationship therewith and then the two combined parts may be attached to the surface from which the sign is to be displayed.

The supporting part 10 has a V-shaped tongue 15 projecting radially inwards substantially at its mid-point, and the combined supporting and framing parts are intended to be placed on the display surface with the tongue 15 at the lowermost position.

In view of the semi-circular and annular relationship of the supporting and framing parts, once the device is in position on a backing surface, then the disc-like sign 12 may be inserted beneath the framing part 11 with the lower half of its circumferential edge resting upon and supported by the upper surface of the supporting part 10. For this purpose a V-shaped notch 16 is provided at what is intended to be the lowermost part of the sign 12 to become engaged with the tongue 15 of the supporting part 10. Thus the tongue 15 and notch 16 serve as location means to ensure that the sign is maintained in an upright disposition and framed by the part 11 whereby, for example, a logo displayed upon the sign 12 is visible through the frame of the part 11. It is then easily removable to be replaced, if and when required, by an alternative sign.

In use, the surface on which the signage device shown in FIG. 1 is mounted will typically be a flat surface on the back of a conference chair, although its uses are manifold and it can be attached to any surface from which a sign is to be displayed while retained in an upright position.

A conference chair designed and produced to receive such a signage device may be provided with an upright smooth surface preferably of bright stainless steel at the back of the chair, thus to be visible when the chair is in use, for example, around a conference table.

In modified versions of the above described signage device, the supporting part 10 and the framing part 11 may be formed integrally as a single piece, for example molded from plastics, in which case self-adhesive material is required only on the surface of the part 10 to be applied to the article surface from which the sign is to be displayed.

In other modified versions of the above described signage device the supporting part 10, whether integral with or attached to the framing part, may be attached by magnetic means to an underlying surface which is made of steel.

Furthermore, the device may be other than strictly circular while still having curvature at the sides and/or the lower region of the device, the tongue and notch 15, 16 being provided to ensure that the sign remains upright irrespective of the curvature of its supporting surface.

Obviously, in modified versions, the notch and tongue maybe provided the opposite way round, the supporting part 10 being provided with a notch while the sign 12 has an inter-engaging tongue. Also these location means may be other than V-shape although the inclined edges of the tongue 15 and notch 16 are such as to provide ease of introduction.

The device enables users interchangeably to display advertising, promotional or aesthetic material or other information as required for a particular event or occasion by quickly and smoothly inserting and removing the sign from its mounted position behind the framing member 11.

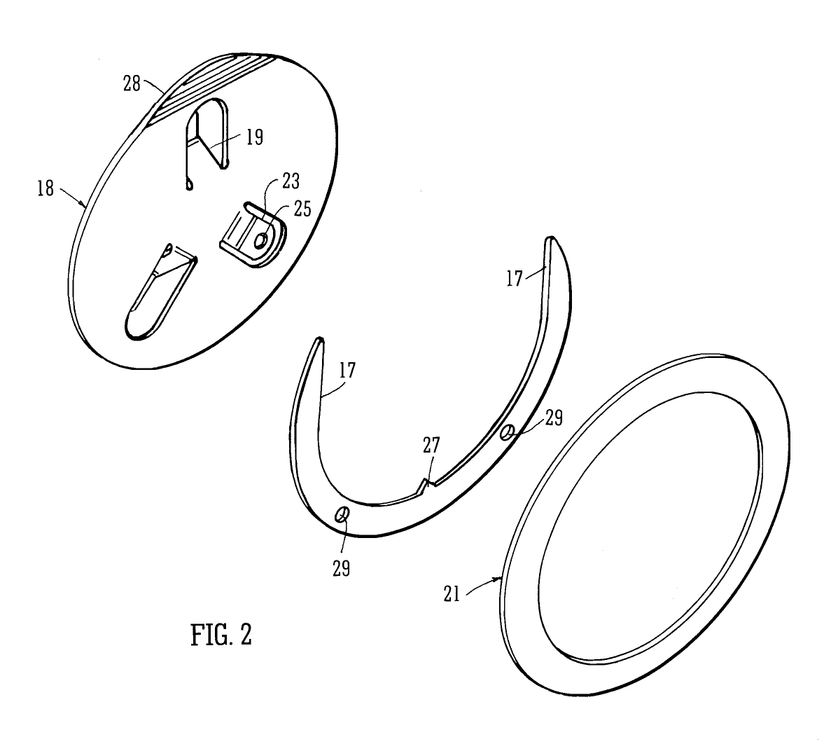

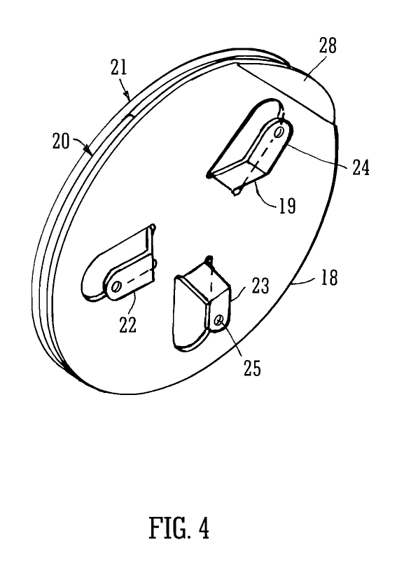

Referring now to FIGS. 2 to 7, these illustrate a second embodiment of the signage or badge mounting device of the invention. This consists of three parts, namely a backing plate 18, a supporting part 20 and a framing part 21. All of these parts may be cut from sheet steel, typically about 1 mm in thickness. However, they may also be produced from any other suitable material.

The backing plate 18 is provided to enable a signage device consisting of a supporting part and a framing part, similar in form to the first embodiment described above, to be attached in an efficient, reliable and removable manner to a wider range of support substrates than may be possible with the first embodiment and its adhesive attachment.

The backing plate 18 is formed as a substantially circular disc which has three legs 19, 22, 23 extending from the rear surface. As shown, these are punched out from the sheet metal as tabs which are bent outwards and then again to provide connector portions 24 which lie spaced above and approximately parallel to the rear surface of the remaining plate. The connector portions are formed with holes 25 for connection to the underlying substrate, typically the back of a chair, by means of screws. Access for fixing the screws is through the cut out portions of the plate 18.

In modified versions the legs may be provided by separate components welded to the rear surface of the backing plate 18, in which case apertures in the plate are required at appropriate overlying positions to allow access for securing or releasing the screws.

The three legs 19, 22, 23 are positioned at substantially equally angular spacing, that is at approximately 60° spacing to each other around the circular plate 18. The leg 19 which is to be the uppermost leg when the backing plate 18 is mounted in use is bent outwards to a lower depth than the other two legs so that, for example, its connector portion 24 may lie about 5 mm from the rear surface of the plate 18, whereas the connector portion 24 of the other two legs 22, 23, may lie at about 7 mm from the rear surface of the plate 18. This specifically adapts this particular embodiment of the device for streamlined fitting to a substrate such as the rear surface of a chair back which is curved or sloped rearwards.

As shown, particularly in the enlarged detail from FIG. 10, and upper edge adjacent region of the backing plate 18 is displaced to a small degree out of the plane of the remaining plate 18 to provide a rearwardly sloping lip 28. This facilitates insertion of a sign in the form of a circular disc, exactly as sign 12 in the first embodiment, between the framing part 21 and the backing plate 18 in the assembled and mounted device.

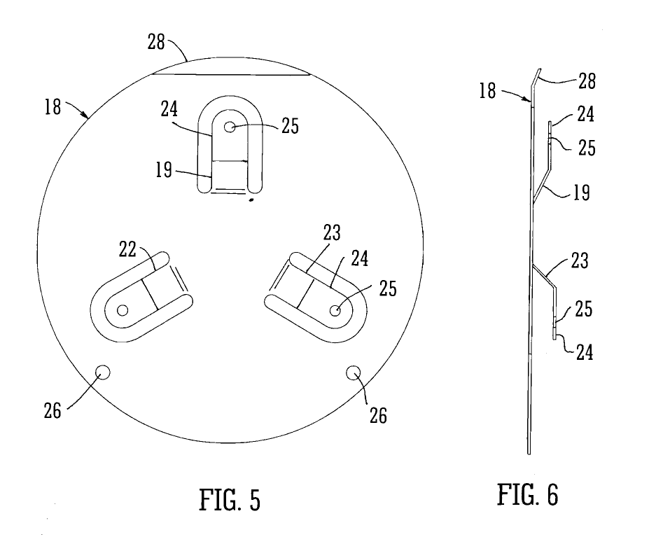

As shown in FIG. 5, the backing plate 18 is formed with two circumferentially spaced shallow protrusions 26 for the purpose of location of the supporting part 20.

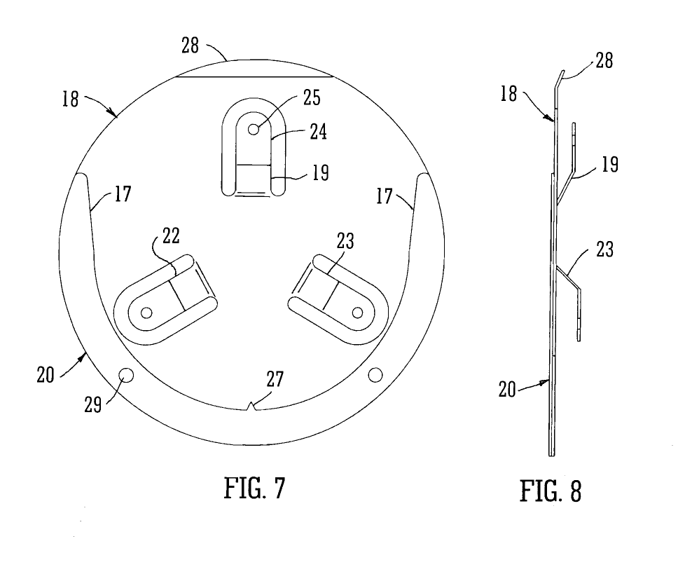

The supporting part 20 has a lower edge of part circular shape which is greater than semicircular, as apparent in FIGS. 2 and 7. Its upper edge, which in use supports the sign, has a central region of no more than semicircular shape, so as to receive the lower half of the circular sign. An upstanding V-shaped tongue 27 is provided at the midpoint of the upper edge, as in the first embodiment, to engage and locate the corresponding notch 16 on the sign 12 and prevent rotation of the sign 12 when mounted within the device. End regions of the upper edge are tapered outwards at 17 to adjoin the lower edge at tips of the part 20. This shape of the supporting part 20 enables speedy and accurate insertion of the sign 12. In this respect at conference facilities there may be several hundred signs/badges which need to be inserted into respective badge mounting devices, or replaced, and this needs to be accomplished with maximum efficiency.

The supporting part 20 has spaced apertures 29 which align with and locate on the protrusions 26 of the backing plate 18 prior to spot welding of the supporting part 20 to the plate 18. FIGS. 7 and 8 shows the supporting part 20 attached onto the plate 18 in this manner.

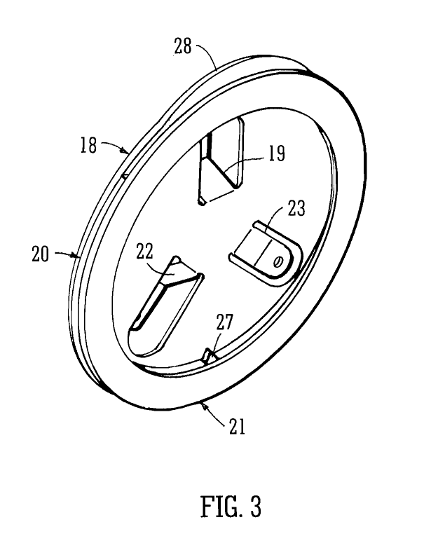

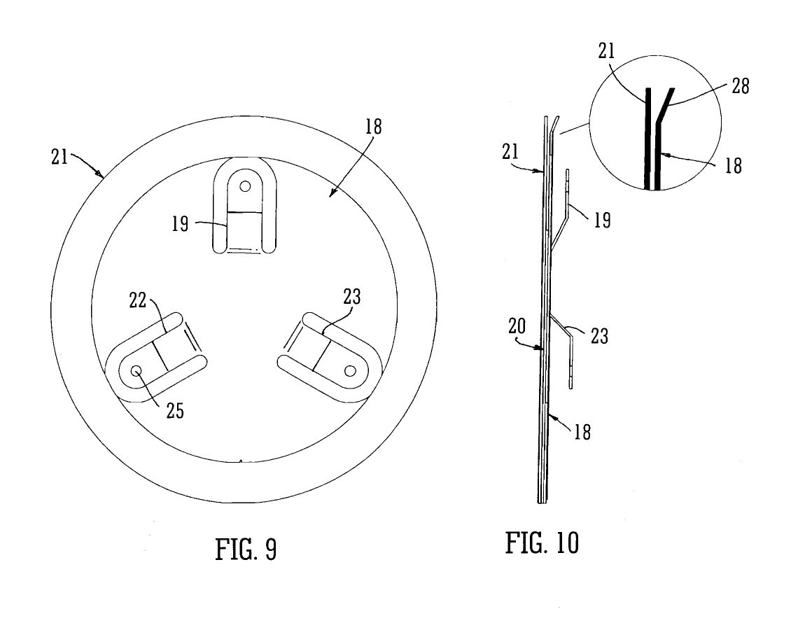

The framing part 21 comprises an annular plate or ring, as in the first embodiment. It is attached to the front face of the supporting part 20 by adhesive. FIGS. 3, 4, 9 and 10 show the fully fabricated device which, other than the protruding legs, has an entire thickness of between 2 and 3 mm, so that it sits closely in a streamlined manner upon an underlying substrate, typically the backrest of the chair, and does not protrude in a way which could lead to it catching on clothing or items carried by people passing by. Furthermore, the manner in which the legs are formed enables attachment to fabric of a chair backrest, again in a streamlined manner, and in a manner which should leave no marks or damage if the device is subsequently removed.

The foregoing describes two embodiments of the invention and certain variants thereof. It is to be understood that the invention is not limited to the precise details of the described embodiments and many variations in design are possible within the scope of the invention as defined by the appended claims.

1. A signage device for attachment to a surface comprising:
a sign having a curved edge region;
a supporting part for attachment to a surface, said supporting part consisting of a flat strip of curved configuration having a concavely curved upper support edge to support the curved edge region of the sign;
and a framing part attached to the supporting part in superimposed relationship thereto to retain and frame the sign when the sign is supported upon the supporting part;
the upper support edge of the supporting part and the curved edge region of the sign having complementary location formations, namely a tongue and a notch, which are configured to engage with each other to maintain the sign in a selected orientation and in a non-rotatable manner relative to the supporting part when, in use, the supporting part is attached to a surface and the sign is inserted behind the framing part and supported upon the upper edge of the supporting part.

2. A signage device as set forth in claim 1, wherein the sign is a circular disc.

3. A signage device as set forth in claim 2, wherein the supporting part has a lower edge of substantially semi-circular shape and its upper support edge is also of substantially semicircular shape.

4. A signage device as set forth in claim 3, wherein the framing part is of annular form corresponding in outer radius to that of the lower edge of the supporting part.

5. A signage device as set forth in claim 2, wherein the supporting part has a lower edge of part circular shape and its curved upper edge has a central region of substantially semi-circular shape and respective end regions tapering from said central region to respective ends which adjoin the lower edge.

6. A signage device as set forth in claim 5, wherein the framing part is of annular form corresponding in outer radius to that of the lower edge of the supporting part.

7. A signage device as set forth in claim 1, wherein the notch and complementary tongue are V-shaped for ease of inter-engagement.

8. A signage device as set forth in claim 1, wherein the supporting part has a self-adhesive material on its surface remote from the framing part, for attachment to a surface.

9. A signage device as set forth in claim 1, wherein the supporting part has a self-adhesive material on its opposed surfaces for attachment to a surface and to the framing part.

10. A signage device as set forth in claim 1, wherein the supporting part and the framing part and the sign are each formed from sheet metal material.

11. A signage device as set forth in claim 1, further comprising a backing plate providing the surface to which the supporting part is attached.

12. A signage device as set forth in claim 5, further comprising a circular backing plate providing the surface to which the supporting part is attached, said backing plate having a radius corresponding to that of the lower edge of the supporting part.

13. A signage device for attachment to a surface for supporting a sign having a curved edge region provided with a locating formation in the form of a tongue or a notch, said device comprising:
a backing plate;
a supporting part attached to said backing plate, said supporting part consisting of a flat strip of curved configuration having a concavely curved upper support edge to support the curved edge region of the sign;
and a framing part attached to the supporting part in superimposed relationship thereto to retain and frame the sign when the sign is inserted between the framing part and the backing plate and supported upon the upper support edge of the supporting part;
the upper support edge of the supporting part having a locating formation, namely a tongue or a notch, which is configured to engage with the locating formation provided on the sign to maintain the sign in a selected orientation and in a non-rotatable manner relative to the supporting part when, in use, the sign is inserted between the framing part and the backing plate and supported upon the supporting part.

14. A signage device as set forth in claim 13, wherein the backing plate is a circular metal disc.

15. A signage device as set forth in claim 14, wherein the supporting part has a lower edge of part circular shape and its curved upper edge has a central region of substantially semi-circular shape and respective end regions tapering from said central region to respective ends which adjoin the lower edge.

16. A signage device as set forth in claim 15, wherein the framing part is of annular form corresponding in outer radius to that of the lower edge of the supporting part.

17. A signage device as set forth in claim 14, wherein the supporting part has a lower edge of part circular shape and of a radius corresponding to the radius of the backing plate.

18. A signage device as set forth in claim 14, wherein the framing part is of annular form corresponding in outer radius to the radius of the backing plate.

19. A signage device as set forth in claim 13, wherein the backing plate is provided with a plurality of legs for attachment to a substrate, said legs being formed from the material of the backing plate by being cut out there from and bent out of the plane of the backing plate at the side of the plate remote from the attachment of the supporting part.

20. A signage device as set forth in claim 19, wherein the backing plate is provided with three legs, one of said legs, intended to be used for securing an upper region of the device to a substrate, being bent out of the plane of the backing plate to a lower depth than the other two legs, which are bent out of the plane of the backing plate to substantially the same depth as each other.

21. A signage device as set forth in claim 13, wherein the backing plate has an upper edge adjacent portion displaced out of the plane of the backing plate as a sloping lip facilitating insertion of the sign between the framing part and the backing plate.
